(19) United States
(12) Patent Application Publication
(10) Pub. No.: US 2012/0035954 A1
(43) Pub. Date: Feb. 9, 2012

(54) ON-DEMAND CLINICAL TRIALS UTILIZING EMR/EHR SYSTEMS

(75) Inventor: Filip Jay Yeskel, Raleigh, NC (US)

(73) Assignee: INTERNATIONAL BUSINESS MACHINES CORPORATION, Armonk, NY (US)

(21) Appl. No.: 12/850,751

(22) Filed: Aug. 5, 2010

(51) Int. Cl. G06Q 50/00

(52) U.S. Cl. 705/3

(57) ABSTRACT

A system, method and program product for selecting cohorts for a clinical trial. An infrastructure is described that includes a system for submitting a query; a matching engine for matching the query against patient metadata obtained from a plurality of electronic medical record/electronic health record (EMR/EHR) systems to identify matching patients; a system for requesting applicable EMR/EHR systems to release patient details of a set of matching patients; and a cohort data repository for collecting patient details from the applicable EMR/EHR systems.

### BACKGROUND

The present invention relates to tools for implementing clinical trials, and more specifically for identifying cohorts for clinical trials using electronic medical record/electronic health record (EMR/EHR) systems.

A development in clinical medicine has been the growing adoption of Electronic Medical Record (EMR) and Electronic Health Record (EHR) systems by healthcare providers. The adoption rate for this technology in the US has been growing geometrically and is about to grow even faster in response to incentives and mandates associated with the Healthcare IT portion of the American Recovery and Reinvestment Act of 2009. It is reasonable to assume that the vast majority of individual health records in the US will be stored in electronic form within a few years. Eventually, such records will be accessible electronically via established network technology and nascent standards now being developed by the US federal Office of the National Coordinator (ONC) of Healthcare IT.

Within the domain of clinical medicine, a well established sequence is typically followed by healthcare providers for diagnosing and treating medical conditions. Once the physician has completed the diagnosis and determined the prognosis, he/she proposes a treatment plan usually according to the guidelines provided by the medical field on the treatment of the particular condition. These guidelines are normally the product of long term (often years in duration) clinical trials whose results are peer reviewed and published in established medical journals.

One significant challenge for performing a clinical study is to identify a set of individuals, i.e., a “cohort,” who is appropriate and willing to participate in a clinical trial.

### BRIEF SUMMARY

The present invention provides a solution for identifying cohorts and implementing clinical trials utilizing source data from EMR/EHR systems. According to one embodiment of the present invention, a system for recruiting a cohort for a clinical trial, comprising: a system for submitting a query; a matching engine for matching the query against patient metadata obtained from a plurality of electronic medical record/electronic health record (EMR/EHR) systems to identify matching patients; a system for requesting applicable EMR/EHR systems to release patient details of a set of matching patients; and a cohort data repository for collecting patient details from the applicable EMR/EHR systems.

In a second embodiment, there is a computer program product for recruiting a cohort for a clinical trial, the computer program product comprising: a computer readable storage medium having computer readable program code embodied therewith, the computer readable program code comprising: program code for receiving a query; program code for matching the query against patient metadata obtained from a plurality of electronic medical record/electronic health record (EMR/EHR) systems to identify matching patients; program code for requesting applicable EMR/EHR systems to release patient details of a set of matching patients; and program code for collecting patient details from the applicable EMR/EHR systems into a cohort data repository.

In a third embodiment, there is a method for selecting cohorts for a clinical trial, comprising: receiving a query; matching the query against patient metadata obtained from a plurality of electronic medical record/electronic health record (EMR/EHR) systems to identify matching patients; requesting applicable EMR/EHR systems to release patient details of a set of matching patients; and collecting patient details from the applicable EMR/EHR systems in a cohort data repository.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings.

FIG. 1 depicts an infrastructure for performing on-demand clinical trials using existing EMR/EHR systems.

FIG. 2 depicts a cohort query form for identifying patients for a clinical trial.

FIG. 3 depicts a set of resulting matches for a cohort query.

FIG. 4 depicts a flow chart showing a method of an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like reference numbering represents like elements.

### DETAILED DESCRIPTION

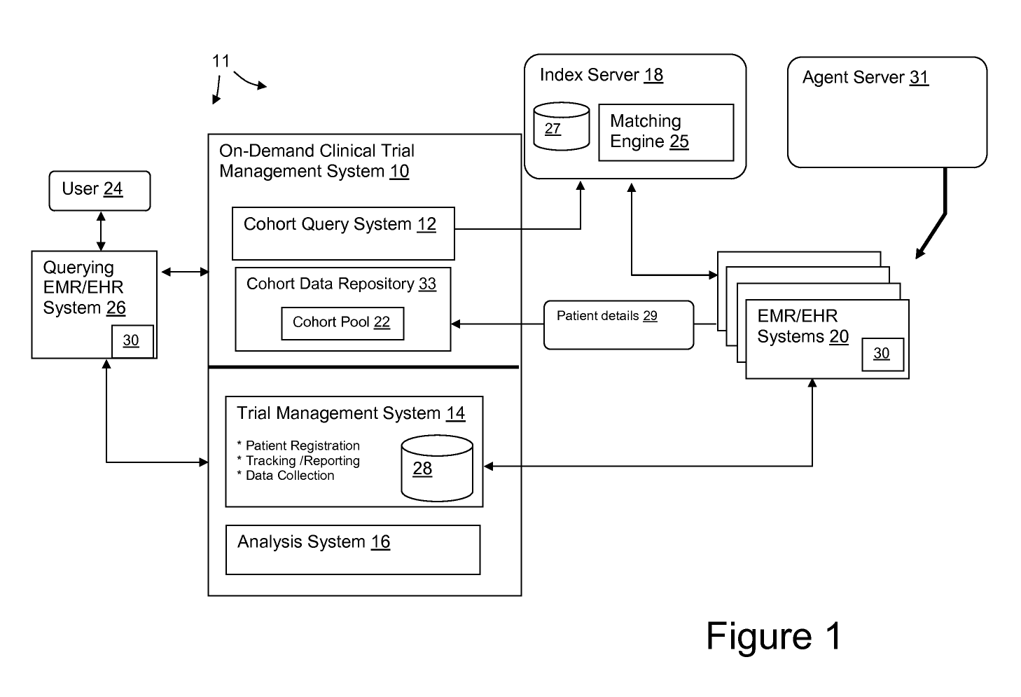

FIG. 1 depicts an infrastructure for performing on-demand clinical trials utilizing existing EMR (electronic medical record)/EHR (electronic health record) systems 20 within a network 11. EMR/EHR systems 20 may comprise any now known or later developed system for managing and storing patient data.

EMR/HER participation is enabled via agents 30 that are for example downloaded or enabled from an agent server 31 to each EMR/EHR system 20. Each agent 30 leverages the native communications capability of the relevant EMR/HER system 20 to enable the information flow described herein. For example, each agent 30 enables patient metadata 27 from each EMR/EHR system 20 to flow to index server 18, in either batch or real time. Given the fact that the majority of health care providers currently or will in the near future utilize an EMR/EHR system 20, the number of participating systems could easily be in the hundreds of thousands or even millions.

An on-demand clinical trial system 10 is provided to allow a user 24 operating within the realm of an EMR/EHR system (in this case “querying EMR/EHR system 26”) to identify one or more cohorts for a clinical trial, manage the implementation of the trial, and analyze the results. Although shown as a single stand-alone system, it is understood that on-demand clinical trial system 10 could be implemented in any fashion, e.g., it could be in part distributed within the peer-to-peer network 11, could be implemented as a SaaS (software as a service) model via a website, could be integrated into an existing EMR/EHR system 20, 26, etc.

As noted above, one of the challenges in implementing a clinical trial is to identify a set of candidates, i.e., a cohort pool 22, that meet the necessary criteria to participate in a trial. For example, a researcher may need to identify people in a defined age range, within disparate geographic regions, who are being treated for one or more predefined conditions, etc. On-demand clinical trial system 10, in combination with network 11, simplifies the process by providing a cohort query system 12 that allows a user 24 at a querying EMR/EHR system 26 to recruit a cohort from among other EMR/EHR systems 20. In an illustrative embodiment, the user 24 inputs a query into cohort query system 12, which then relays the query to a matching engine 25. The query is matched against a collection of indexed patient metadata to identify matching patients, i.e., those patients that can be used to form a cohort pool 22. The patient metadata is obtained by the index server 18 from the EMR/EHR systems 20 using either “push” or “pull” techniques over time (e.g., as a batch transmission from otherwise idle EMR/EHR systems during the night). The cohort query system 12 presents a set of matching patients to the querying user 24 (i.e., investigator). The cohort query system 12 may allow the querying user 24 to refine the query in an iterative way, e.g., via an interface. Once a set of matching patients are identified, patient details 29 (i.e., cohort data) are made available to the user 24 via transfer from the applicable subset of EMR/EHR systems 20 to the cohort data repository 33, which may or may not be co-resident in the querying EMR/EHR system 26. Since the index server 18 is not involved in this data transfer, it can be considered a peer-to-peer data transfer. Using the cohort data, a cohort can be recruited from the cohort pool 22 to participate in the trial. A trial management system 14 may be utilized to manage and view patient details, register candidates, provide tracking/reporting, collect and manage data, etc. An analysis system 16 can then be used to analyze data collected for the trial.

An illustrative process for such an implementation is as follows. Individually, and over time, a large universe of individual EMR/EHR systems 20 load index server 18 with metadata associated with patient information, (this metadata typically being a small subset of the actual patient details they contain). Any of a wide variety of batch or real time load processes can be used. The load may for instance take place during otherwise idle periods of the EMR/EHR systems 20. The process is similar to, but much simpler than, the ETL (extract transform load) of data from operational data stores into CDW systems. Over time, the index server 18 accumulates an increasingly complete index of the patient data held in the EMR/EHR systems 20.

A querying EMR/EHR system 26 utilizes cohort query system 12 which interfaces with matching engine 25 to query the index server 18 metadata for matches to a desired set of cohort criteria. E.g., female, age range xx, weight range yy, primary diagnosis zz, co-morbidities yyy, zzz, treatment xyz, outcome www, etc. The query format may, for example, utilize SOAP over HTTP web service with data format compliant with the nascent Health Information Exchange (HIE) Query for Existing Data or any other mechanism compliant with emerging HIE standards. The index server 18 may, for example, be a cross-enterprise document sharing (XDS) Registry component of an HIE system.

Matching engine 25 identifies the patients sufficiently matched to the inputted query and thereby the applicable subset of EMR/EHR systems 20 that contain associated detailed patient data. The degree of match can be set by configurable thresholds, and any type of matching logic may be used. Optionally, a human operator may further refine the match results via a user interface. Once the relevant EMR/EHR systems 20 are identified, the index server 18 directly notifies the applicable EMR/EHR systems which patient data is requested, along with unique address of the querying system 26. The notification accordingly requests that the applicable EMR/EHR systems release patient details 29 to the cohort data repository 33.

EMR/EHR systems 20 which receive the notification, and are enabled, capable, and willing to send a response, send their individual replies containing detailed patient data of matching patients to the cohort data repository 33 and thereby to the querying EMR/EHR system 26. The cohort data repository 33 may, for example, be the XDS Repository portion of an HIE system. The index server 18 does not participate in this phase of the data transfer. Any type of data transfer mechanism, including file transfer, is possible. The data format might, for example, be compliant with the nascent IHE Multi-Patient Query (MPQ) format. As noted, EMR/EHR systems 20 are enabled via downloaded, pre-installed, or add-on software agents 30 that reside in the same local software environment as the EMR/EHR system 20.

Accordingly, the described infrastructure allows the typically manual and limited scope process of cohort selection to be performed automatically or semi-automatically and over a very wide scope of potential cohorts (i.e., all patients in the collection of networked EMR/EHR systems 20). Not only is this process made easier and more complete for the investigators, but the granularity of discovery in cohort selection is improved. In some cases, e.g., the size, geographic distribution, age distribution, etc., of the cohort pool 22 may itself provide useful information to researchers. These advantages are true for both retrospective and prospective clinical studies.

Another advantage is that the user 24 need not be a trained researcher, i.e., the user need not necessarily be a specially trained investigator in an academic medical setting but might be a primary care physician simply looking for anyone else who has a patient within a matching demographic and with a matching set of symptoms.

Once a cohort pool 22 is identified, trial management system 14 can be used to sign up candidates for a trial. To achieve this, part of the patient information returned from the query may include contact information, e.g., a phone number, address or email address for the patient. An automated system, such as a mass email blast, a letter generator or automated phone dialing system may be utilized to contact potential cohorts. An on-line interface may be utilized to allow patients to sign up for the study. A database 28 may be utilized to collect and track data from the registered members of the resulting cohort. Accordingly, the entire clinical trial could be automated such that little or no human intervention is required.

Thus, the trial management system 14 allows the data collection phase of a clinical study to be conducted with less effort, across a significantly wider scope, and possibly with finer granularity than current mechanisms. In order to accomplish the latter, the index server 18 reply to the cohort selection query can include meta-information about the data available for each of the selected individuals. The querying EMR/EHR system 30 and the replying EMR/EHR systems 20 can use this meta-information to limit the data transmission to only a subset of the total data available for a given patient. This may simplify the researcher's data analysis task, and certainly reduces the bandwidth and time required for data transmission.

Although not shown, it is understood that the, identification, transfer, management, and analysis of patient data described above is, of course, subject to regulatory and other requirements regarding patient authentication, authorization, and confidentiality. The mechanisms for such are known in the art, assumed to be incorporated in the processes above, and outside the scope of this invention. Although not shown, it is further understood that on-demand clinical trial system 10 may include additional architectural layers to provide security, patient anonymization, auditability, patient opt-in, etc.

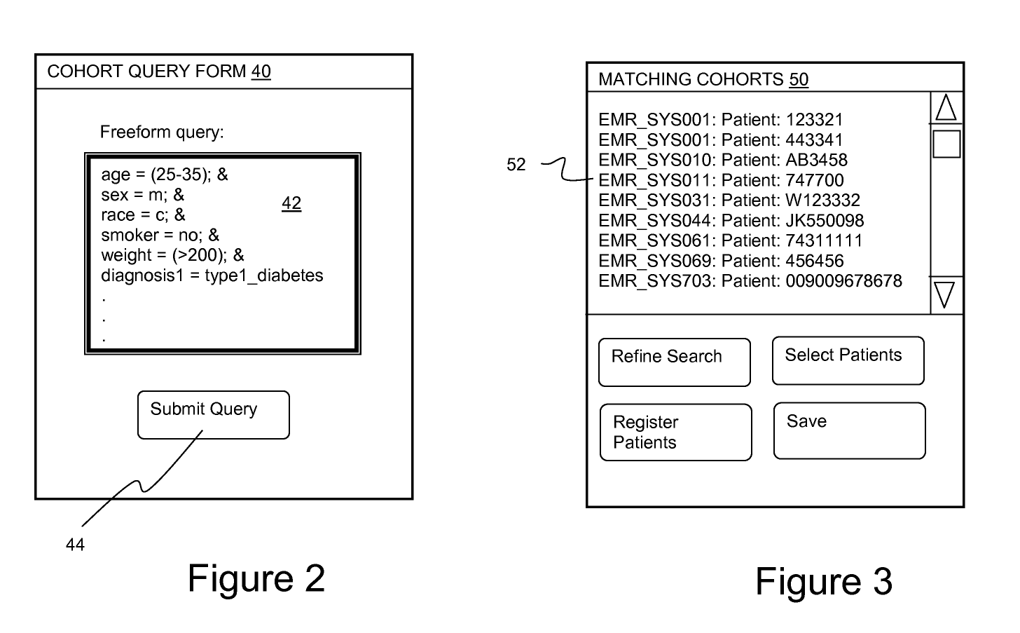

FIG. 2 depicts an illustrative cohort query form 40 for use within cohort query system 12 (FIG. 1). In this embodiment, a user enters a freeform query into a query dialog window 42 and then submits the query via a query submit button 44. It is understood that FIG. 2 depicts but one of any number of graphical interfaces for submitting a query and any other type of interface could be utilized, e.g., drop down selections, forms, etc.

FIG. 3 depicts an illustrative interface 50 for displaying matching cohorts (i.e., a cohort pool) within cohort query system 12 (FIG. 1). In this case, a list of patient records 52 who match the inputted query are returned and displayed. In this display, each record 52 lists the EMR/EHR system on which the patient was located and a patient identifier. From this interface, a user can, e.g., refine the search, select a cohort pool for a clinical trial, register patient for the cohort, save the list, etc. Obviously, the interface 50 depicts one possible embodiment for view and processing matching cohorts, and any other type of interface could likewise be utilized.

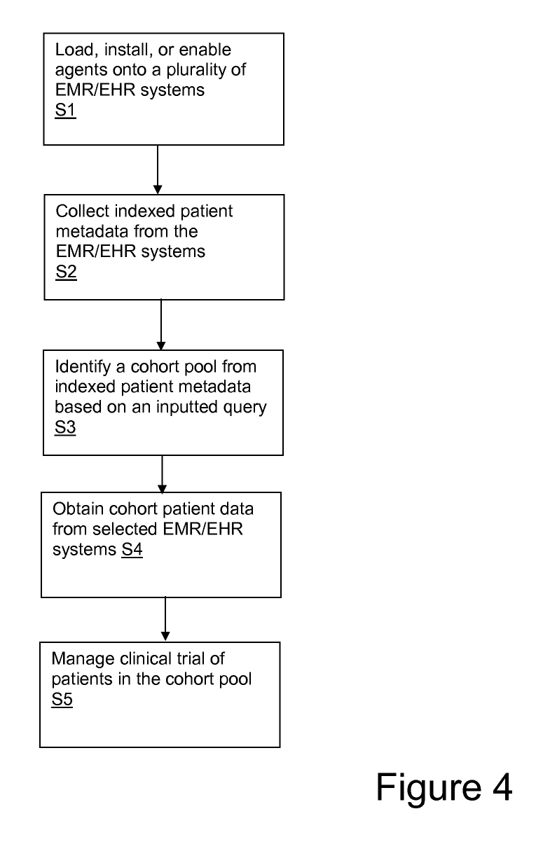

FIG. 4 depicts a flow chart showing an illustrative methodology. At S1, agents are loaded, installed, or enabled onto a plurality of EMR/EHR systems. At S2, patient metadata is collected from the plurality of EMR/EHR systems and indexed. At S3, a cohort pool is identified from the indexed patient metadata based on an inputted query. At S4, detailed patient data is obtained from the selected EMR/EHR systems. At S5, a clinical trial of patients in the cohort pool is managed, e.g., with a set of tools for registering, collecting and processing cohort information.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including Instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for recruiting a cohort for a clinical trial, comprising:
a system for submitting a query;
a matching engine for matching the query against patient metadata obtained from a plurality of electronic medical record/electronic health record (EMR/EHR) systems to identify matching patients;
a system for requesting applicable EMR/EHR systems to release patient details of a set of matching patients; and
a cohort data repository for collecting patient details from the applicable EMR/EHR systems.

2. The system of claim 1, further comprising an interface for displaying and managing data associated with the matching patients and patient details.

3. The system of claim 1, further comprising an index server for accumulating indexed patient metadata from the plurality of EMR/EHR systems.

4. The system of claim 1, further comprising:
a trial management system for managing a clinical trial involving a cohort obtained from the cohort data repository; and
an analysis system for analyzing results of the clinical trial.

5. The system of claim 1, further comprising a system for enabling agents on each of the plurality of EMR/EHR systems.

6. The system of claim 1, wherein the patient metadata includes a subset of the patient details stored on the plurality of EMR/EHR systems.

7. The system of claim 1, wherein the system for inputting the query is enabled by a graphical user interface.

8. A computer program product for recruiting a cohort for a clinical trial, the computer program product comprising:
a computer readable storage medium having computer readable program code embodied therewith, the computer readable program code comprising:
program code for receiving a query;
program code for matching the query against patient metadata obtained from a plurality of electronic medical record/electronic health record (EMR/EHR) systems to identify matching patients;
program code for requesting applicable EMR/EHR systems to release patient details of a set of matching patients; and
program code for collecting patient details from the applicable EMR/EHR systems into a cohort data repository.

9. The computer program product of claim 8, further comprising an interface for displaying and managing data associated with the matching patients and patient details.

10. The computer program product of claim 8, further comprising program code for managing a clinical trial involving a cohort obtained from the cohort data repository and for analyzing results of the clinical trial.

11. The computer program product of claim 8, further comprising program code for installing and configuring agents on each of the plurality of EMR/EHR systems.

12. The computer program product of claim 8, wherein the patient metadata includes a subset of the patient details stored on the plurality of EMR/EHR systems.

13. The computer program product of claim 8, wherein the program code for receiving the query comprises a graphical user interface.

14. A method for selecting cohorts for a clinical trial, comprising:
receiving a query;
matching the query against patient metadata obtained from a plurality of electronic medical record/electronic health record (EMR/EHR) systems to identify matching patients;
requesting applicable EMR/EHR systems containing matching patients to release patient details of the matching patients; and
collecting patient details from the applicable EMR/EHR systems in a cohort data repository.

15. The method of claim 14, further comprising collecting indexed patient metadata from the plurality of EMR/EHR systems at an index server.

16. The method of claim 14, further comprising providing an interface for displaying and managing data associated with the matching patients and patient details.

17. The method of claim 14, further comprising managing a clinical trial involving a cohort obtained from the cohort data repository and analyzing results of the clinical trial.

18. The method of claim 14, further comprising enabling agents at each of the plurality of EMR/EHR systems.

19. The method of claim 14, wherein the patient metadata includes a subset of the patient details stored on the plurality of EMR/EHR systems.

20. The method of claim 14, wherein the query comprises a set of criteria.
